(19) United States
(12) Patent Application Publication
(10) Pub. No.: US 2014/0061210 A1
(43) Pub. Date: Mar. 6, 2014

(54) Two-State Automatically Deploying Container Insulators and Methods of Use

(71) Applicant: RINGSULATE, LLC, Ipswich, MA (US)

(72) Inventors: Harrison O'Hanley, Ipswich, MA (US); Mario Bollini, Sterling Heights, MI (US)

(73) Assignee: RINGSULATE, LLC, Ipswich, MA (US)

(21) Appl. No.: 13/785,568

(22) Filed: Mar. 5, 2013

Related U.S. Application Data
(60) Provisional application No. 61/697,287, filed on Sep. 5, 2012.

(51) Int. Cl. A47G 19/22; B23P 11/00

(52) U.S. Cl. CPC A47G 19/2288; B23P 11/00
USPC 220/592.25; 29/428

(57) ABSTRACT

Two-state automatically deploying container insulators and methods of making same are disclosed. In some embodiments, an insulated container may include a container for holding therein one or more substances in need of insulation. The insulated container may also include an insulator disposed inside the container. The insulator may be moveable between a compressed state when the container is pressurized and an expanded state when the container is de-pressurized.

### RELATED APLICATIONS

This application claims the benefit of and priority to U.S. Provisional Application No. 61/697,287, which was filed on Sep. 5, 2012, and which is incorporated herein by reference in its entirety.

### SUMMARY

The present disclosure relates to insulated containers, and more particularly, to automatically activated insulators for use in various containers.

### BACKGROUND

Beverage containers are ubiquitous devices. Container types include aluminum cans and bottles, plastic and glass bottles, and paper cartons. The materials and geometries selected for common beverage containers offer easy manufacturing and low cost. However, a common disadvantage among beverage containers is the inability to insulate the beverage from thermal transfer with the external environment.

This disadvantage is particularly noticeable when serving cold beverages. Prior to consumption, the beverage container (and thus beverage within) is refrigerated, lowering its temperature. During consumption, the temperature of the beverage rises rapidly from contact with the user's warm hand, as well as from additional heat transfer with the surrounding environment.

A common solution is to utilize an external insulating device, which surrounds the beverage container. Commonly made of foam, such devices mitigate warming of the beverage by inhibiting heat transfer to the beverage from the user's hand and the environment. However, this strategy requires the use of a second, external device during beverage consumption. As a result, the overall cost and complexity of consuming a beverage is increased. The foam insulating cylinder often has a much larger diameter than the beverage container, which prevents the use of commonly sized cup-holders. It also alters the commonly accepted form factor of the beverage container for the user.

More recently, double walled beverage containers have been designed, with an air gap separating the two walls. This air gap creates a large thermal resistance, helping to insulate the beverage within. The air gap thickness is typically small and thus the container geometry is minimally altered. Additionally, the insulator is integrated into the primary container package. While such devices are easy to manufacture, because these devices include double walls they require substantially more material (close to twice as much aluminum, plastic, or glass as a similarly sized single walled container).

The major disadvantage of both the external foam cylinder and double walled container devices is that they are active during both refrigeration and consumption. Therefore, while the devices delay the warming of a beverage during consumption, they also delay the cooling of a beverage during refrigeration. This is undesirable in many situations where beverages must be cooled rapidly and immediately prior to consumption.

There is thus still a need for an insulated container that can address the shortcomings of external insulators and double-wall containers.

### SUMMARY

Two-state automatically deploying container insulators and methods of making same are disclosed. In some embodiments, an insulated container may include a container for holding therein one or more substances in need of insulation. The insulated container may also include an insulator disposed inside the container. The insulator may be moveable between a compressed state when the container is pressurized and an expanded state when the container is de-pressurized.

In some embodiments, an insulated container may include an insulator, which can be configured to fit inside a container for holding therein one or more substances in need of insulation. The insulator may include a first side and a second side, which may define an insulating volume filled with an insulating material. The insulator may be moveable from a compressed state to an expanded state in response to change in pressure of the one or more substances.

In some embodiments, a method for insulating a substance inside a container is disclosed. Initially, an insulator may be disposed inside a container holding one or more substances. The insulator may be compressed by pressurizing the container in order to permit thermal transfer into the one or more substances from environment outside of the container. Alternatively, to reduce the thermal transfer into the one or more substances from the environment outside of the container, the insulator may be allowed to expand by depressurizing the container.

### BRIEF DESCRIPTION OF THE DRAWINGS

The presently disclosed embodiments will be further explained with reference to the attached drawings, wherein like structures are referred to by like numerals throughout the several views. The drawings shown are not necessarily to scale, with emphasis instead generally being placed upon illustrating the principles of the presently disclosed embodiments.

FIG. 1A is an exploded view of an embodiment of an insulated container of the present disclosure.

FIG. 1B illustrates an embodiment of an insulator of the present disclosure.

FIG. 1C illustrates an embodiment of an insulator of the present disclosure.

FIG. 1D illustrates an embodiment of an insulator of the present disclosure.

FIG. 2 illustrates an embodiment of an insulator in the expanded state.

FIG. 3 is a vertical cross section of an embodiment of an insulator in the expanded state.

FIG. 4 is a detail view of FIG. 2, focused on the encircled area A in FIG. 3.

FIG. 5 illustrates an embodiment of an insulator in the compressed state.

FIG. 6 is a vertical cross section of the insulator in the compressed state.

FIG. 7 is a detail view of FIG. 5, focused on the encircled area B in FIG. 6.

FIG. 8A and FIG. 8B illustrate an embodiment of an insulator inside a container.

FIG. 9 is a cut away view of an embodiment of an assembled insulated container including an insulator in the compressed state.

FIG. 10 is a detail view of FIG. 9, focused on the encircled area C in FIG. 9.

FIG. 11 is a cut away view of an embodiment of an assembled insulated container of the present disclosure including an insulator in the expanded state.

FIG. 12 is a detail view of FIG. 11, focused on the encircled area D in FIG. 11.

FIGS. 13-16 illustrate various modeling parameters for modeling thermal transfer in and out of an insulated container of the present disclosure.

FIG. 17 presents a graph showing modeled behavior of an embodiment of an insulated container of the present disclosure.

FIG. 18 presents a graph showing experimental results for an embodiment of an insulated container of the present disclosure.

While the above-identified drawings set forth presently disclosed embodiments, other embodiments are also contemplated, as noted in the discussion. This disclosure presents illustrative embodiments by way of representation and not limitation. Numerous other modifications and embodiments can be devised by those skilled in the art which fall within the scope and spirit of the principles of the presently disclosed embodiments.

### DETAILED DESCRIPTION

The present disclosure provides an insulated container including an insulator that capitalizes on the internal beverage pressure for deployment.

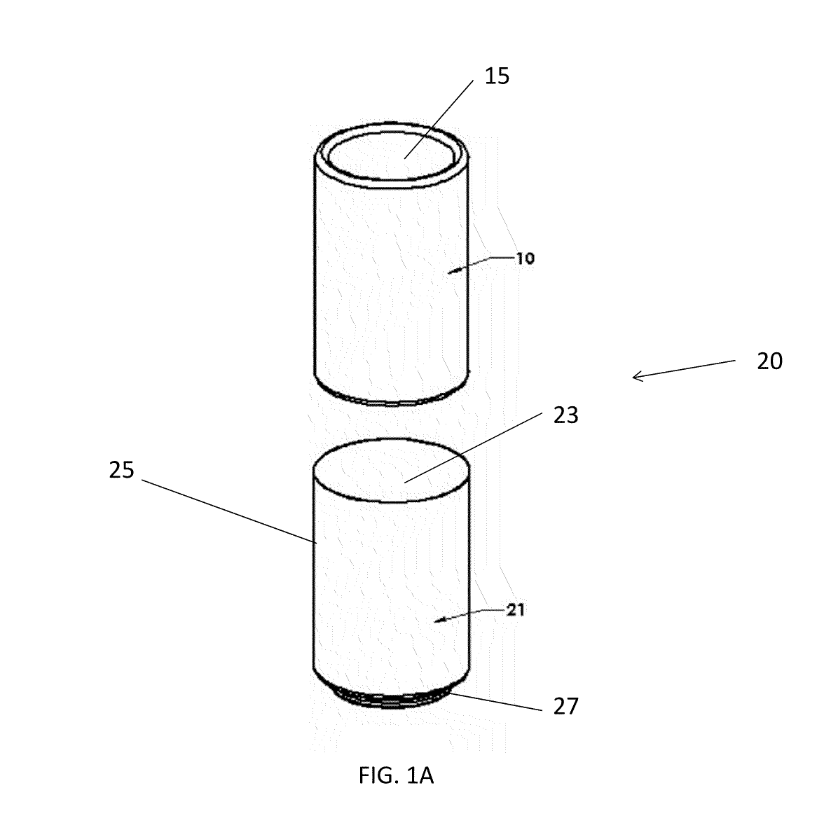

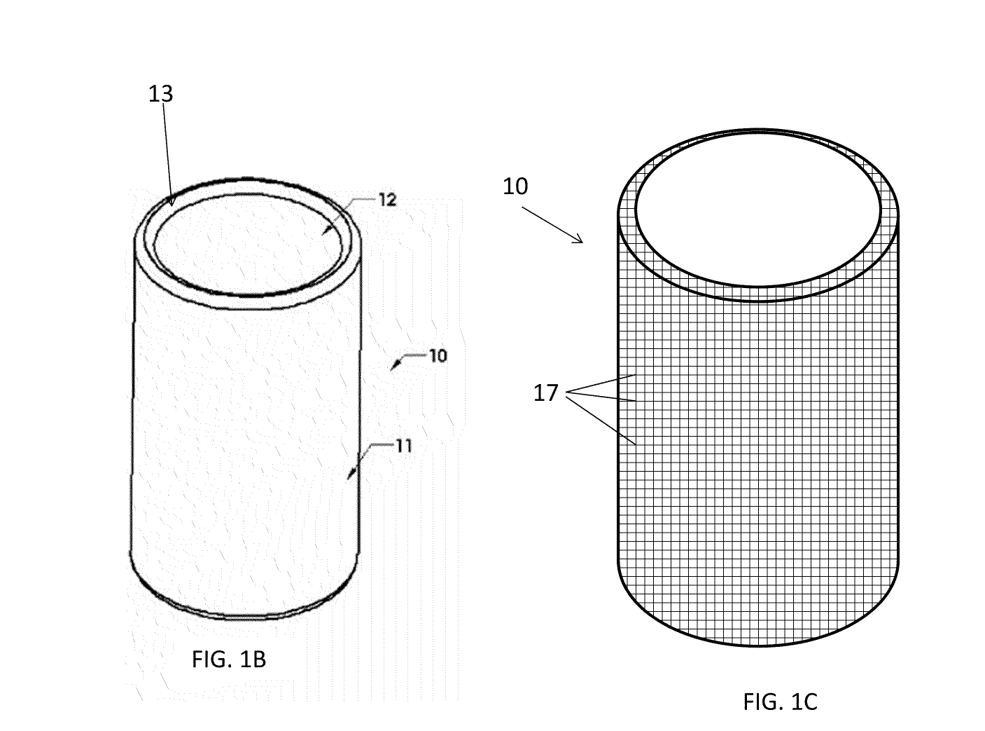

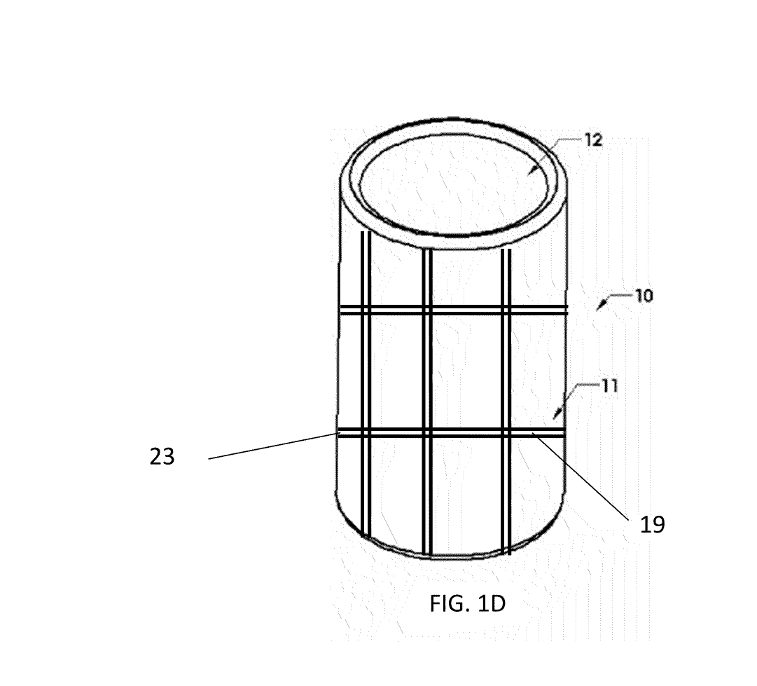

In reference to FIG. 1A, in some embodiments, an insulated container 20 includes an outer container 21. The outer container 21 may be any type of a container for holding a beverage, such as, by way of a non-limiting example, aluminum cans and bottles, plastic and glass bottles, paper cartons or a similar container. As shown in FIG. 1A, walls 25 and a base 27 of the outer container 21 define a cavity 23 within which a beverage, an insulator or both can be accommodated. It should, of course, be understood that while the insulated containers of the present disclosure are described as beverage containers, the insulated containers of the present disclosure may be used with any other material or substance, edible or non-edible, in need of insulation from the surrounding environments. Accordingly, the outer container 21 may have any shape suitable for holding therein one or more materials or substances in need of insulation. The outer container 21 may be designed for a single use or multiple uses.

The insulated container 20 may further include an insulator 10 designed to be inserted into the inner cavity 23 of the outer container 21 to regulate thermal transfer between the insulated container 20 and the surrounding environment. The insulator 10 may be configured to respond to changes in pressure to move between a compressed state, in which the insulator 10 allows thermal transfer through the insulator 10, and an expanded state, in which the insulator reduces thermal transfer through the insulator 10.

In some embodiments, the insulator 10 may have a shape complimentary to the shape of the outer container 21. In this manner, the insulator 10 may be fitted inside the inner cavity 23 and substantially conform to the walls 25 of the outer container 21. In some embodiments, a snug fit may be created between the insulator 10 and the outer container 21, when the insulator 10 is inserted into the cavity 23 of the outer container 21. The insulator 10 may be connected and secured to the outer container 21 using an appropriate adhesive. In some embodiments, adhesives may not be used, and a secured fit may be achieved by expansion of the insulator 10 against the outer container 21. In some embodiments, the fit between the insulator 10 may and the outer container 21 may be substantially loose to allow the insulator 10 to move within the outer container 21.

The insulator 10, in some embodiments, may include a hollow interior 15 into which a beverage may be poured. While FIG. 1A illustrates the insulator 10 as a hollow cylinder, the insulator 10 may have other shapes as long as the insulator 10 may be conformally fitted into the cavity 23 of the outer container and includes a hollow interior 15 for holding therein a beverage. In some embodiments, the insulator 10 may be closed on the bottom of the cylinder to prevent thermal transfer through the base 27 of the outer container 21. In some embodiments, the outer wall of the insulator 10 abuts the inner wall of the outer container 21 and a beverage is placed in the hollow interior of the insulator 10, therefore, the insulator may act as barrier to thermal transfer from the environment to the beverage, as is explained below.

In reference to FIG. 1B, in some embodiments, the insulator 10 may include an outer side 11 and an inner side 12 defining an inner volume 13 therebetween. The inner volume 13 of the insulator 10 may be filled with an insulating material to provide insulation and resist heat transfer across the insulator 10 to the beverage held in the insulated container 20 from the surrounding environment. In some embodiments, the inner volume 13 may be filled with any material that has insulating capacity. Suitable insulating materials include, but are not limited to, air, inert gas, various foams (closed cell or other) or combinations thereof. In some embodiments, the insulating material may include a chemical agent, by itself or in combination with another insulating material or another material, the chemical agent being activatable by a change in the shape or size of the insulator 10, as will be described in detail below. The inner volume 13 may be a single pocket, as shown in FIG. 1B, or may be divided into a plurality of smaller volumes 17, as shown in FIG. 1C. In some embodiments where the inner volume 13 is divided into a plurality of smaller volumes, the smaller volumes of the inner volume 13 can be filled with the same or different insulating materials.

The inner volume 13 of the insulator 10 may be compressible due to the presence either of a gas, foam or other insulating material inside the inner volume 13. When the insulator 10 is exposed to ambient pressure, the nominal internal pressure of the insulator 10 may cause the insulator 10 to expand to its nominal thickness. Such state of the insulator 10 may be referred to herein as a neutral state or expanded state. The insulator 10 may be compressed into a compressed or collapsed state by applying pressure to the insulator 10. When the pressure is removed, the insulator 10 may be allowed to transform back to the expanded state. In some embodiments, the insulator 10 may be compressed when a beverage in the insulated container 21 is pressurized, and the insulator 10 may be allowed to move to an expanded state when a beverage in the insulated container 21 is depressurized, such as when the insulated container 20 is opened and exposed to atmospheric pressure. In some embodiments, the insulator 10 may be designed for a single use. In other embodiments, the insulator 10 may be designed for multiple uses. In such embodiments, the material for the insulator 10 may be selected to allow the insulator 10 to expand and contract multiple times, as desired.

In the expanded state, the internal volume 13 of the insulator 10 may have a specifically set internal pressure, p_{insulator,expanded} and a specifically set thickness, t_{insulator,expanded}. In some embodiments, the inner volume 13 may have a thickness between about 0.02 inches and about 0.10 inches, when expanded. Of course, the insulator 10 may have a different thickness depending on the specific application. In the compressed state, when the walls of the insulator 10 are substantially pressed against one another, the internal volume 13 may have the internal pressure p_{insulator, compressed} and the thickness t_{insulator, compressed}. Thermal transfer across the insulator 10 is a direct function of its thickness. A large thickness may inhibit thermal transfer more than a small thickness. Because t_{insulator,expanded} is greater than t_{insulator, compressed}, the insulator 10 can provide better insulation in the expanded state than in the compressed state. In the compressed state, the insulator 10 is essentially inactivated, permitting thermal transfer between the beverage in the insulated container 20 and the surrounding environment. However, when the insulator 10 is allowed to expand to its expanded thickness, the thickness of the insulator 10 increases, thereby activating the insulator 10 to prevent thermal transfer between the outside the outer container 21 and the beverage in the container 21. In the case of an insulator comprised of multiple smaller and separated insulating volumes, the individual behavior of each volume may be similar to that described above with respect to the insulator 10 having a unitary inner volume. The number of individual insulating pockets on such an insulator can be characterized by the insulator site density (number of insulating pockets per unit area).

In some embodiments, the insulator 10 may have a small reservoir volume, providing space for the compressed gas when the insulator 10 is in a compressed state. This may enable the thickness of the insulator 10 to be reduced to essentially the thickness of the walls of the insulator 10 during the compressed state. The reservoir may be created by including a pre-allocated space in the insulator to accommodate a gas volume. This volume may take any geometrical shape and may protrude into the beverage. The insulating material may preferentially fill the reservoir volume rather than the volume of the insulator 10 as it requires less strain energy.

In some embodiments, outer surfaces of one or both walls of the insulator 10 may be textured to further improve insulating properties of the insulator 10. In some embodiments, the outer surface of the wall of the insulator 10 that comes in contact with the beverage may be textured in a manner to attract carbon dioxide bubbles (which have precipitated out of solution in the beverage, if it is carbonated) to attach to the surface during consumption. In this manner, a further level of gaseous insulation may be added to prevent thermal transfer between the beverage in the insulated container 20 and the surrounding environment. In some embodiments, the outer surface of the wall of the insulator that contacts the wall of the outer container 21 may be textured in a manner to alter the thermal contact resistance between the insulator and the wall of the outer container.

In reference to FIG. 1D, in some embodiments, the insulator 10 may include a stiffener 19 disposed within the inner volume 13 of the insulator 10. The stiffener 19 may be configured to maintain the insulator 10 in the expanded state to ensure that the insulator 10 remain active in preventing thermal transfer between a beverage in the insulated container 20 and the surrounding environment. In some embodiments, the stiffener 19 may be collapsible to allow the insulator 10 to be transformed into the compressed state. In some embodiments, the stiffener 19 may be formed from hollow ducts 23, which can fill up with air as the insulator 10 expands to expand the stiffener 19 and to render the stiffener 19 sufficiently rigid to support the insulator 10 in the expanded state. In some embodiments, the stiffener 19 may be manufactured from a solid material. Other configuration may also be employed, as long as the stiffener is capable to be moved from a collapsed state to an expanded state, and vice versa, as desired.

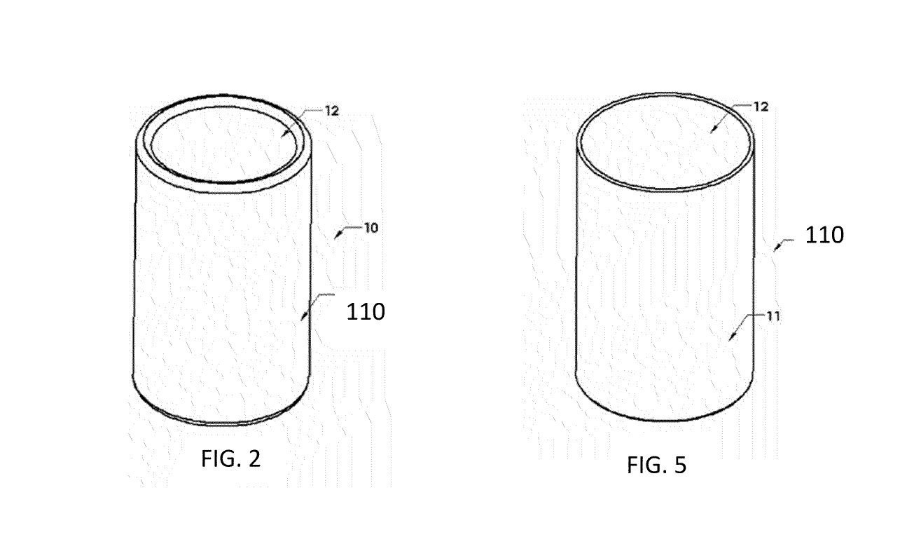

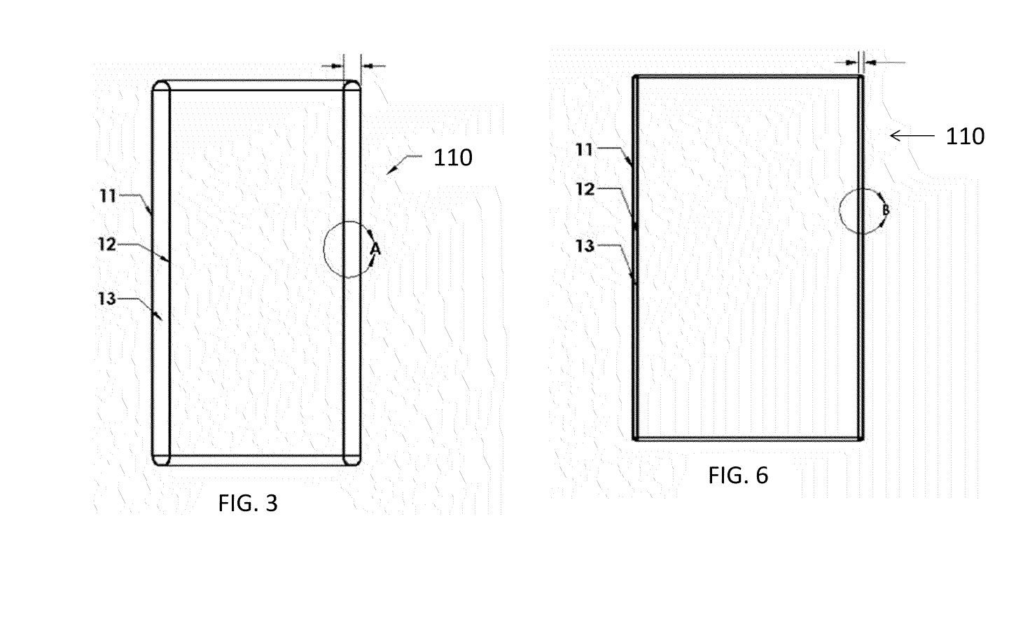

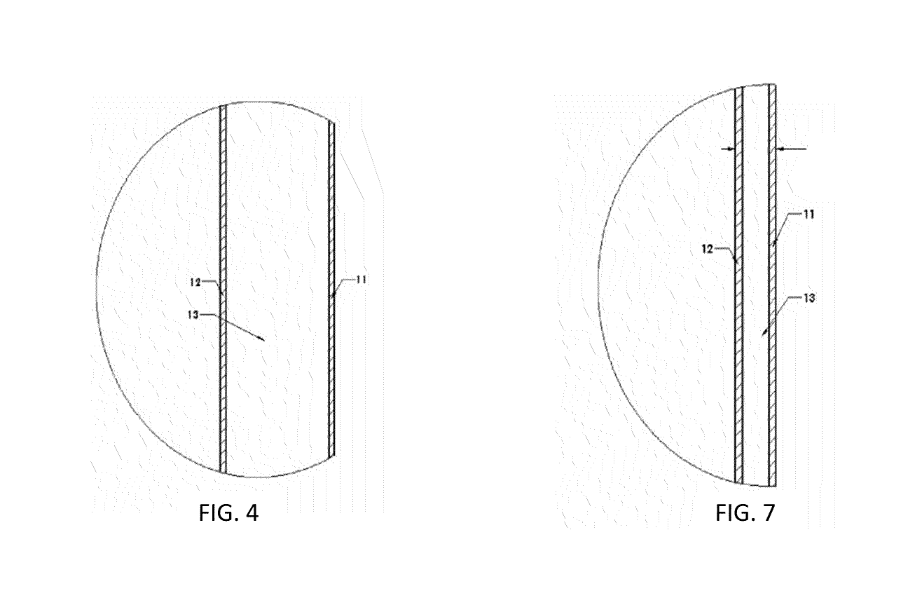

In reference to FIGS. 2-7, in some embodiments, the insulator 10 may be a double-wall insulator 110 having an outer wall 11 and inner wall 12, which define the sealed inner volume 13 there between. When the double-wall insulator 110 is in a compressed state, as shown in FIGS. 5-7, the outer wall 11 and the inner wall 12 are pushed against one another so the inner volume 13 is compressed. As the double-wall insulator 110 moves into the expanded state, the outer wall 11 and the inner wall 12 are allowed to move apart to open up the inner volume 13, as shown in FIGS. 2-4. In some embodiments, to allow the double-wall insulator 110 to move from the compressed state to the expanded state the double-wall insulator 110 may be made from plastic, metal or another material as long as the double-wall insulator 110 can move between its states. In some embodiments, the double-wall insulator 110 may be made from a thin material so the walls of the double-wall insulator 110 do not interfere with thermal transfer between the insides of the insulated container 20 and the surrounding environment, when the double-wall insulator 110 is in a compressed state. In some embodiments, the material for the double-wall insulator 110 may be thicker but compressible. In this manner, when the double-wall insulator 110 is in a compressed state, the walls as well as the inner space of the double-wall insulator 110 may be compressed to a minimal thickness in order not to interfere with the thermal transfer. In the expanded state, the walls of the double-wall insulator 110 can be expanded to provide additional resistance to thermal transfer between the insulated container 20 and the surrounding environment.

The double-wall insulator 110 may be manufactured by a variety of methods. In some embodiments, the double-wall insulator 110 may be manufactured by heat sealing of an inert thin plastic sheet to create the sealed inner volume 13. By way of a non-limiting example, the plastic sheet may be folded upon its midline in one direction and the two free ends may be heat sealed. The resulting double walled sheet may then be rolled into a cylinder and the two free ends may be heat sealed. Prior to fully sealing the plastic sheet, the internal volume 13 may be pressurized by filling the internal volume 13 with a desired amount or volume of the insulating material. In other embodiments, the insulator may be sealed with inert adhesive. The double-wall insulator 110 may also be fabricated via extrusion, molding or any other applicable manufacturing process for thin inert plastics or metals.

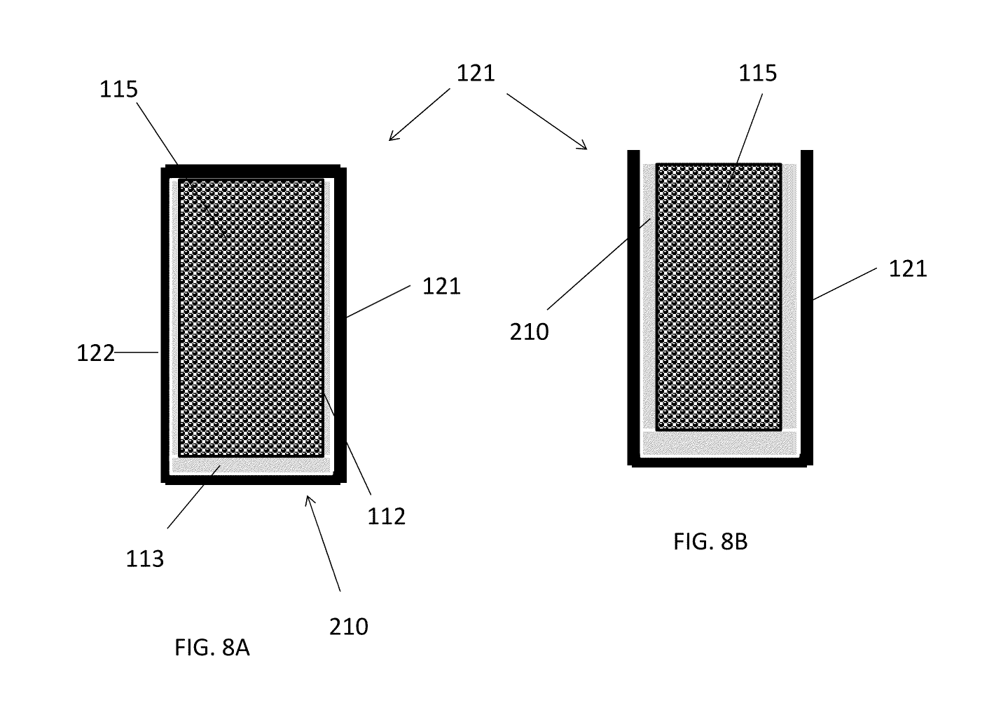

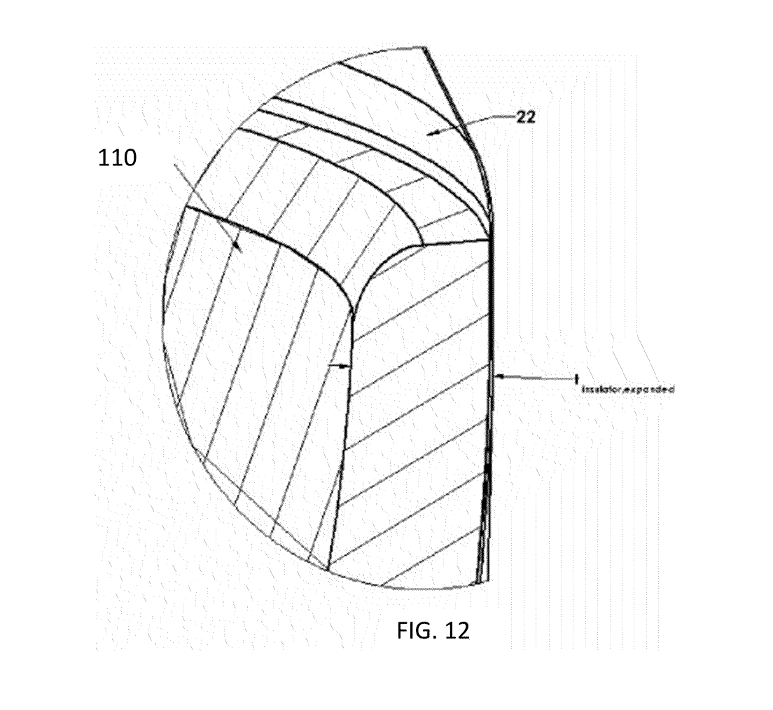

In reference to FIG. 8A and FIG. 8B, another embodiment of an insulated container 120 is illustrated. In this embodiment, the insulator 210, also referred to as a single-wall insulator, is formed by an inner surface of a wall 122 (first side) of an outer container 121 and an insulator wall 112 (second side). There is an inner volume 113 defined between the inner surfaces of the wall 122 of the outer container 121 and the insulator wall 112. The inner volume 113 may be filled with an insulating material as described above. The secondary wall 112 may be flexible or collapsible so the single-wall insulator 210 can be reversibly transformed between a compressed state, as shown in FIG. 12A, and an expanded state, as shown in FIG. 12B. In reference to FIG. 12A, when a beverage 115 contained within the insulated container 120 is pressurized, the pressure in the insulated container 120 may cause the insulator wall 112 to be pressed toward the wall 122 of the outer container 121. As a result, the single-wall insulator 210 may be moved to a compressed state to minimize the thickness of the single-wall insulator 210 and to allow thermal transfer between the beverage 115 contained within the insulated container 120 and the surrounding environment. In reference to FIG. 12B, when the insulated container 120 is depressurized, the single-wall insulator 120 may be allowed to move to an expanded state to maximize the thickness of the single-wall insulator 120 and to control thermal transfer between the beverage 115 contained within the insulated container 120 and the surrounding environment.

In some embodiments, the insulator 10 may be a compressible material having two sides defining the inner volume 13 therebetween. In some embodiments, such compressible material may be a compressible foam, closed cell or otherwise, including a plurality of air pockets. In some embodiment, suitable foam insulator may be fabricated as an extruded annulus of the desired geometry and cut to length to fit within the outer container 21. A non-foam compressible material may also be used, as long, as such material is capable of responding to changes in pressure to move between a compressed state to allow thermal transfer therethrough and an expanded state to reduce thermal transfer therethrough.

In some embodiment, the insulator 10 may comprise multiple smaller volumes, as discussed above. Such insulators may be fabricated in a manner similar to bubble-wrap type plastic packaging. A sheet of the insulating volume containing material can be wrapped into a shape corresponding to the shape of the outer container and heat sealed to create the desired geometry.

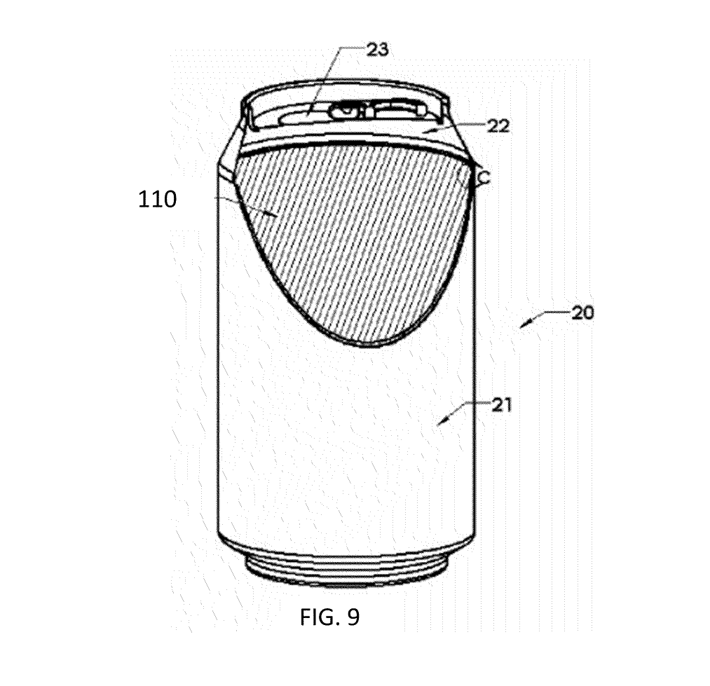

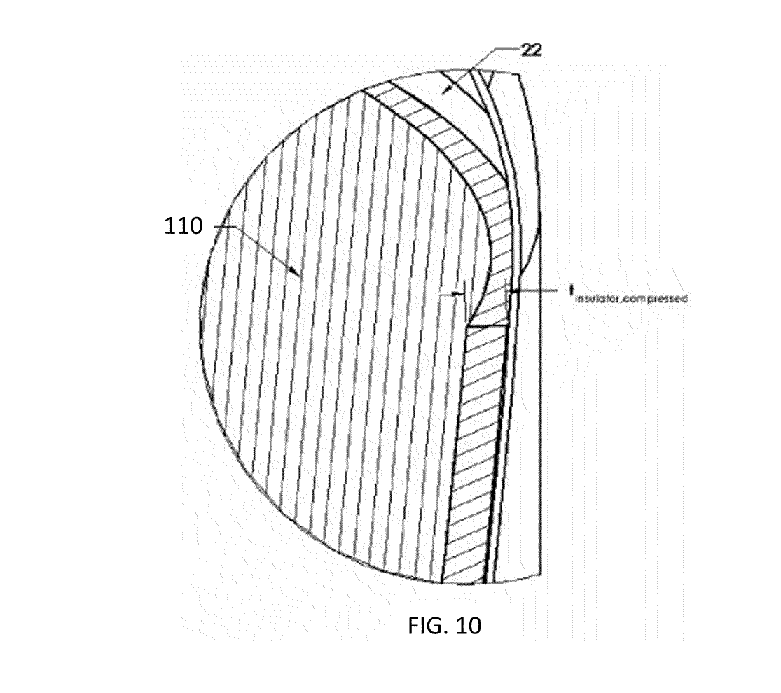

FIGS. 9-13 illustrate the manufacturing and operation of the insulated container 20 of the present disclosure.

The insulated container 20 may be assembled by inserting the insulator 10 into the outer container 21. In some embodiments, the insulator 10 and the outer container 21 may be manufactured separately, and then the insulator 10 may be inserted into the outer container 21. In some embodiments, where the outer container 21 may be a can, the insulator 10 may be inserted into the outer container 21 prior to attaching a top to the outer container 21, such as shown in FIG. 1. In some embodiments, the insulator 10 may be manufactured in situ and concurrently with the outer container 21.

Typically, at this stage of the manufacturing process, the insulator 10 may be at atmospheric pressure and, thus, in the expanded state. In some embodiments, however, to facilitate insertion of the insulator 10 into the outer container 21, the insertion of the insulator 10 into the outer container 21 may occur within an elevated pressure environment, which would partially or fully compress the insulator making assembly easier. Compressing the insulator 10 prior to its insertion into the outer container 21 may be particularly advantageous if the outer container is a bottle or another container with a small orifice through which the insulator 10 must be passed. In some embodiments, the insulator 10 may be fabricated, but not filled with insulating material. In this skeleton state, the insulator 10 may be inserted into the container and then filled with the insulating material in-situ via an extendable straw or any other mechanism. Again, this strategy may be advantageous if the outer container 21 has a small orifice.

Once the insulated container 20 is assembled, a beverage may be added to the insulated container 20 and the insulated container 20 may be sealed to contain the insulator therein. Filling the insulated container 20 with a beverage and pressurizing the beverage, if not already pressurized, transfers the insulator 10 into a compressed state.

FIG. 9 illustrates an assembled insulated container 20 with the insulator 10 in the compressed state due to the presence of beverage under pressure in the insulated container 20. The orifice 23 of the insulated container 20 is closed, maintaining a high internal container pressure, p_{container,high}. This high pressure is imparted to the system during the beverage canning or bottling process. The high internal pressure may push the insulator 10 against the inner wall of the outer container 21, compressing the insulator 10 to its compressed thickness, t_{insulator, compressed}.

FIG. 10 offers a detailed view of a compressed insulator 10. In the compressed state, the insulator thickness may be minimized. At a small thickness, the insulator may offer very little, or no, thermal resistance to the system. In effect, the insulator may be inactive and may permit thermal transfer between the beverage inside the insulated container 20 and the surrounding environment. In some embodiments, when the insulator 10 is in a compressed state, a beverage in the insulated container 20 is capable of being refrigerated at a rate comparable to typical (without insulator 10) beverage containers.

Accordingly, the compressed state of the insulator 10 may be the desired state when the temperature of the beverage in the insulated container 20 needs to be changed to that of the environment surrounding the insulated container 20. For example, during refrigeration, the inactive insulator may allow the beverage in the insulated container 20 to be cooled in a refrigerator in a timely manner. Alternatively, the inactive insulator 10 may allow the beverage in the insulated container 20 to heated, as desired.

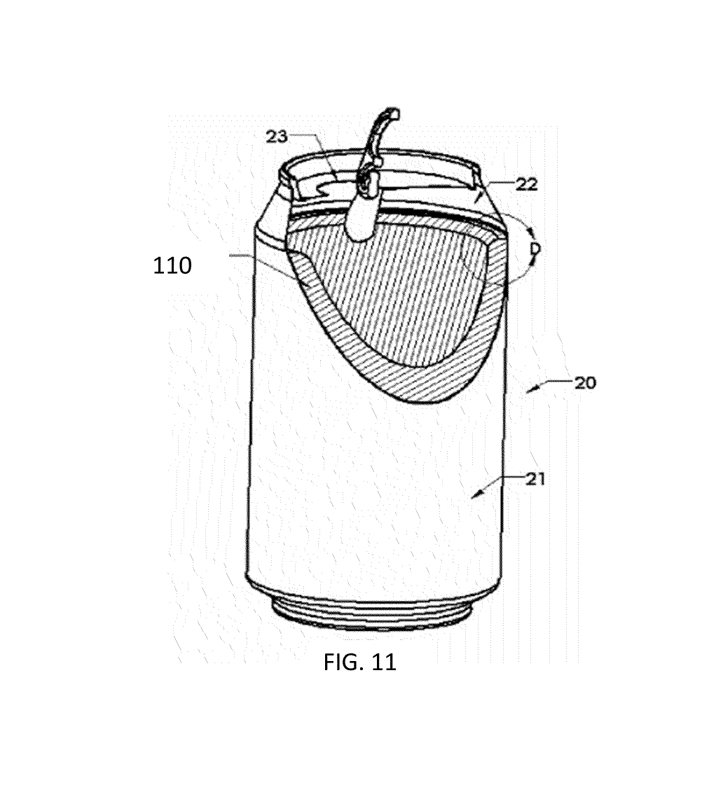

FIG. 11 illustrates the insulated container 20 that has been open, lowering the pressure inside the insulated container 20 and allowing the insulator 10 to expand to an expanded state. That is, the insulator may be automatically deployed when the insulated container 20 is depressurized. Orifice 23 of the insulated container 20 may be open, allowing the internal container pressure to equalize with the ambient pressure, p_{container,ambient}. The ambient pressure would typically be less than the nominal internal pressure of the insulator, p_{insulator,expanded}. Therefore, the insulator 10 may be allowed to expand to its nominal thickness t_{insulator,expanded}.

FIG. 12 offers a detailed view of an expanded insulator 10. In the expanded state, the thickness of the insulator 10 may be maximized. Because the ability of the insulator 10 to insulate the beverage is a function of the thickness of the insulator, the larger thickness of the insulator 10 offers larger thermal resistance. As explained above, in some embodiments, the thickness of the walls of the insulator 10 may be negligible, and thus the thickness of the insulator is essentially the spacing or inner volume 13 between the walls of the insulator 10. In other embodiments, the walls of the insulator 10 in the expanded state may be sufficiently thick to contribute to the insulation properties of the insulator 10. Accordingly, in the expanded state, the insulator may be active or insulating and can prevent heat transfer between the beverage in the insulated container 20 and the surrounding environment. Even when the insulated container 20 is depressurized, the outer wall 11 of the insulator 10 may remain in contact with the inner wall of the container 22 to minimize the thermal transfer between the beverage in the insulated container 20 and the surrounding environment. The expanded state may thus be the desired state when the temperature of the beverage in the insulated container 20 needs to remain substantially unchanged. For example, during consumption of a cold beverage, the active insulator may prevent heat transfer between the cold beverage and the warmer surrounding environment to allow the beverage to maintain its cold temperature during consumption. Alternatively, when consuming a hot beverage, such as tea or coffee, the active insulator 10 may prevent cooling off of the hot beverage.

The behavior of the pressure, thickness, and thermal resistance characteristics of the insulator in the expanded and compressed states are further reviewed through the different stages of use. While the following discussion focuses on the insulator 10, same principles are applicable to characteristics of the single-wall insulator 120.

As fabricated, the insulator 10 may be initially in its expanded state, with an internal insulator pressure of p_{insulator,expanded} and an insulator thickness of t_{insulator,expanded}. During assembly of the insulated container 21, the pressure in the insulated container 20, p_{container,ambient}, is equal to the ambient pressure. The internal pressure of the expanded insulator is equal to or greater than the ambient insulated container pressure. Therefore, the insulator remains expanded because p_{insulator,expanded}≧p_{container,ambient}.

When the insulated container 20 is filled with beverage, the insulated container 20 is pressurized to p_{container,high}, and sealed, resulting in p_{container,high}>p_{container,ambient}. The initial, expanded pressure of the insulator 10 is less than the higher container pressure, and thus: p_{container,high}>p_{insulator,expanded}. The material from which the insulator 10 is made maybe flexible so the insulator 10 can deform under pressure. As a result, the pressure of the internal volume of the insulator 10 may equalize to the higher container pressure: p_{container,high}=p_{insulator,compressed}. The increase in pressure within the insulator 10 may cause the internal insulator volume 13 to decrease, which in turn, may cause the insulator thickness to transition to a compressed state with t_{insulator,compressed}. In the compressed state, the thermal resistance of the insulator, R_{insulator,compressed} is minimal. Accordingly, when the insulator 10 is in the compressed state, thermal transfer between the beverage in the insulated container 20 and the surrounding environment may not be effected or only marginally effected.

When the insulated container 20 is depressurized, such as by, for example, opening the insulated container 20 orifice to unseal the insulated container 20, the pressure within the insulated container 20 may be reduced to p_{container,ambient}, which is less than p_{container,high}. The internal insulator pressure is greater than the ambient pressure of the insulated container 20, as described above. Therefore, the internal volume of the insulator 10 may expand and the insulator may returns to its expanded state, with a thickness t_{insulator,expanded}. The thickness of the expanded insulator 10 is larger than the thickness of the compressed insulator (t_{insulator,expanded}>t_{insulator,compressed}). Therefore, the thermal resistance of the expanded insulator 10 is much greater than the thermal resistance of the compressed insulator, that is, R_{insulator,expanded}>>_{Rinsulator,compressed}. Accordingly, when the insulator 10 is in the expanded state, thermal transfer between the beverage in the insulated container 20 and the surrounding environment may be prevented.

The performance and design of the insulator can be described and optimized through various analytical models. The following discussion presents exemplary calculations for modeling the performance and design for a suitable insulator, but is should be remember that various other models may also be used.

Two fundamental calculations may be performed to size the insulator 10: 1) a heat transfer analysis and 2) a pressure and geometry balance. The first calculation offers insight into the thermodynamic processes during warming of a beverage and may establish the geometry requirements of the insulator 10. The latter calculation may size the insulator 10 to satisfy the previously established parameters, as well as to integrate with industry standard beverage containers.

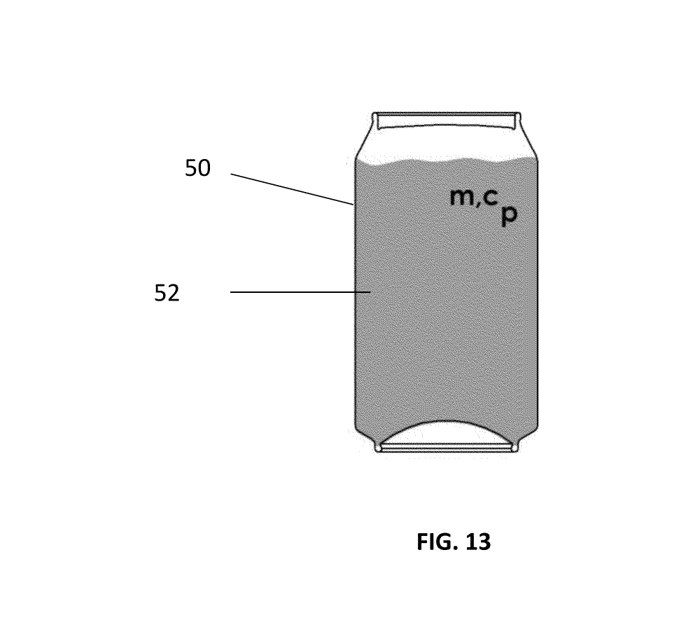

The heat transfer, in particular, the warming of a beverage, can be modeled with traditional thermodynamic and heat transfer equations. This allows for both the prediction of beverage temperature as a function of time during consumption, as well as the optimization of the insulator 10 design. In reference to FIG. 13, for example, a beverage 52 in a typical can 50 has a mass, m, and a specific heat capacity, cₚ, which is a measure of the liquid's ability to contain heat energy. Using the first law of thermodynamics, a relationship can be established between the energy in and the temperature of the system. Equation (1) below illustrates the system behavior, where Q is energy and T is temperature:

Q=mcₚT

The heat transfer process between the beverage and the surrounding environment can be modeled with a thermal circuit. However, before analyzing the system of interest, a generalized, simple heat transfer system should be considered. In this model, there are two regions with distinct temperature, T₁ and T₂, separated by a general thermal resistance (e.g. conduction, convection or radiation), R. As with the beverage can, the body at temperature T₁ has the properties, m and cₚ. This general scenario may be illustrated by a general thermal circuit below:

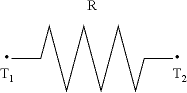

It can be assumed that T₂ is constant (for example, the ambient environment), while T₁ can vary with time, t, (a heating or cooling object). In a similar fashion to an electrical circuit, a general thermal circuit can be modeled mathematically as shown in Equation (2) below:

$$\dot{Q} = \frac{Δ T}{\sum R} = \frac{( {T}_{2} - {T}_{1} ( t ) )}{R}$$

Where, \dot{Q} is the heat flux, ΔT is the overall temperature difference in the system and ΣR is the summation of all the thermal resistances.

Next, Equation (1) can be differentiated with respect to time, yielding Equation (3) below:

$$\dot{Q} = m {c}_{p} \frac{d T}{d t}$$

Equations (2) and (3) are set equal and re-arranged, resulting in, Equations (4) and (5) below:

$$m {c}_{p} \frac{d {T}_{1}}{d t} = \frac{( {T}_{2} - {T}_{1} ( t ) )}{R}$$

$$\frac{d {T}_{1}}{d t} = \frac{1}{m {c}_{p} R} ( {T}_{2} - {T}_{1} ( t ) )$$

The differential equation in Equation (5) may be solved resulting Equation (6) as follows:

$${T}_{1} ( t ) = {T}_{2} + ( {T}_{1} ( 0 ) - {T}_{2} ) {e}^{- t / τ}$$

$$τ = \frac{1}{m {c}_{p} R}$$

where T₁(0) is an specified initial condition for T₁ and τ is the time constant of the system, which will be useful in the future for design optimization. Therefore, through this general solution, the time-dependent temperature of a given object can be mathematically solved for as a function of its ambient surroundings and insulation (thermal resistance).

Thermal Model of Normal Beverage Container

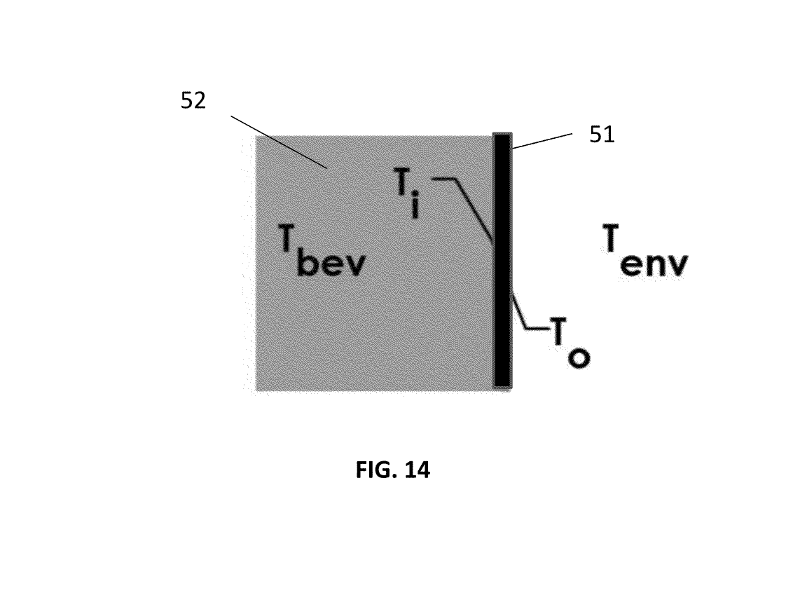

A thermal model of normal beverage container may also be prepared. This mathematical procedure can be applied to a typical beverage can 50. FIG. 14 is a zoomed in view of a wall 51 of the beverage can 50 containing the beverage 52. As shown in FIG. 14, four temperatures govern the heat transfer process: T_{bev} is the bulk temperature of the liquid in the container, Tᵢ is the temperature at the inside of the beverage container wall, Tₒ is the temperature at the outside of the beverage container wall, and Tₑₙᵥ is the temperature of the ambient environment surrounding the beverage container.

Under normal circumstances, heat transfer between the environment and the liquid may involves three distinct processes: 1) Convection at the inside of the container, between the liquid and the container wall; 2) Conduction across the aluminum wall (an essentially negligible process due to the thinness of the wall and for aluminum cans, the high thermal conductivity of the container material); and 3) Convection at the outside of the container, between the container and the surround environment.

The beverage can 50 can be modeled with a thermal circuit, below, with each heat transfer process representing a thermal resistance.

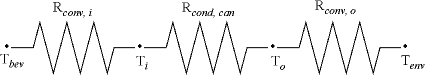

Applied to the beverage container, Equation (2) takes the form of Equation (7) below:

$$\dot{Q} = \frac{{T}_{env} - {T}_{bev} ( t )}{{R}_{conv , i} + {R}_{cond , can} + {R}_{conv , o}}$$

Where, R_{conv,i}, R_{cond,can}, and R_{conv,o} are the thermal resistances of the inner convection, conduction through the container wall, and outer convection, respectively. It should be noted also that T_{bev} is expressed as a function of time. A similar mathematical procedure can be followed to calculate T_{bev} as a function of time, resulting in Equation (8) as follows:

$${T}_{bev} ( t ) = {T}_{env} + ( {T}_{bev} ( 0 ) - {T}_{env} ) {e}^{- t / τ}$$

$$τ = \frac{1}{m {c}_{p} ( {R}_{conv , i} + {R}_{cond , can} + {R}_{conv , o} )}$$

There may exist a few methodologies to determine the various thermal resistances. First, they can be calculated from established equations and correlations. For example, conduction through the container wall can be modeled with the heat equation in cylindrical coordinates.

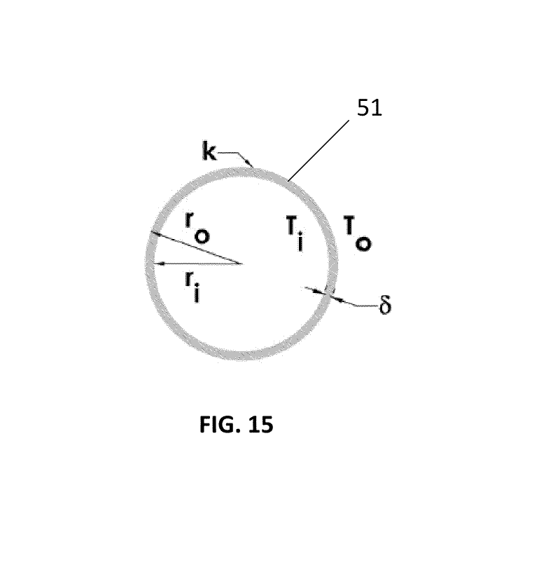

Considering the general case of heat conduction through a cylinder having a wall 51, as depicted in FIG. 15, the cylinder has an inner and outer radii, rᵢ and rₒ, which are at temperatures, Tᵢ and Tₒ, respectively. The thickness of the cylinder is δ (simply rₒ-rᵢ) and the cylinder material's thermal conductivity is k.

The heat equation applied to this scenario is shown as Equation (9) below:

$$\frac{d}{d r} ( r \frac{d T}{d t} ) = 0$$

The solution to this differential Equation (9) can be presented as Equation (10) below:

T(r)=A ln(r)+B

Where A and B are constants that can be determined through the application of boundary conditions. Through the solution of this common equation, the following relationship (11) between the temperature of the inner and outer walls can be established:

$${T}_{i} - {T}_{o} = \frac{\dot{Q}}{2 π L k} ln ( \frac{{r}_{o}}{{r}_{i}} )$$

Where L is the height of the cylinder (e.g. its dimension into or out of the page). Using Equations (2) and (11), the thermal resistance for conduction through a cylindrical barrier can be established as Equation (12) below:

$${R}_{cond} = \frac{ln ( \frac{{r}_{o}}{{r}_{i}} )}{2 π Lk}$$

This thermal resistance can be applied in the case of the beverage container wall and also later in the design of the insulator 10.

Convection Thermal Resistance

Next, a model for the thermal resistance of the convection heat transfer processes may be modeled. Correlations are relied up to derive the heat transfer coefficient, h, which is directly related to R, as shown in Equation (13) below, where A is the area of the heat transfer surface:

$$R = \frac{1}{hA}$$

Generally, heat transfer at the outer container surface can be considered a case of free convection. In other words, the air flow over the outside of the container has no significant velocity. To determine the heat transfer coefficient, the non-dimensional Nusselt number, Nu, can be calculated. This number represents the ratio of convective to conductive heat transfer across a boundary surface. To calculate the Nusselt number, the Rayleigh, Ra_{L}, and Prandtl, Pr, non-dimensional numbers may also be considered. The Rayleigh number helps to describe buoyancy driven flow; while the Prandtl number is the ratio of momentum diffusivity to thermal diffusivity. In this scenario, the non-dimensional Nusselt number and its dependent terms are calculated as shown in Equations (14), (15), (16), (17) and (18) below:

$$Nu = \frac{{[ 0.825 + 0.387 {Ra}_{L}^{\frac{1}{6}} ]}^{2}}{{[ 1 + {[ \frac{0.492}{Pr} ]}^{\frac{9}{16}} ]}^{\frac{9}{27}}}$$

$${Ra}_{L} = \frac{g β}{υ a} ( {T}_{s} - {T}_{∞} ) {x}^{3}$$

$$Pr = \frac{υ}{a}$$

$$a = \frac{k}{ρ {c}_{p}}$$

$$β = \frac{1 d ρ}{ρ dT}$$

Where,
g is gravitational acceleration
Ts is the surface temperature
T∞ is the quiescent temperature (e.g. the temperature of the fluid far away from the surface)
x is the characteristic length, which in this case is the height of beverage container
v is the fluid kinematic viscosity
α is thermal diffusivity, as defined above.
β is the thermal expansion coefficient, as defined above.
ρ is the fluid density

It should be noted that the above correlation for the Nusselt number (14) is primarily for application to free convection at a vertical wall. As a first approximation, this correlation can be applied to the cylindrical geometry encountered with a beverage can, though more detailed correlations specifically derived for cylindrical geometries can also be used. Using Equations (14) through (18), the Nusselt number can be determined and then related to the heat transfer coefficient as shown in Equation (19) below:

$$Nu = \frac{hx}{k}$$

Finally, the heat transfer coefficient is used with Equation (12) to determine the thermal resistance at the beverage container outer surface.

Convection at the inner surface can also be modeled. Because the fluid exists in an enclosed space, same or different correlations may be used to model convection at the inner surface. Separate correlations have been established for enclosed convection across a variety of geometries. However, they are quite complex and difficult to achieve accuracy with. As is discussed below, it may be simpler and more accurate to determine the thermal resistances empirically.

Empirical Determination of Thermal Resistance

To determine the sum of the three thermal resistance terms in the beverage container, a simple experiment may be run. A beverage container (here, a soda can) is refrigerated for an extended period of time such that its contents are in at a uniform temperature. The can is removed from the refrigerator, opened, and placed in a normal consumption environment (e.g. in a room temperature environment).

Three temperature measurements are made: 1) A thermocouple is placed in the center of the liquid within the container, measuring T_{bev}; 2) A thermocouple is adhered to the outer wall of the container, measuring Tₒ; and 3) A temperature probe is situated away from the container and measures the room temperature, Tₑₙᵥ.

The can is allowed to warm up to the ambient room temperature, while these measurements are constantly recorded. This data set may offer much insight into the container thermal model. First, using temperature measurements 1 and 3, along with Equation (8), the total sum of the thermal resistances, R_{container,emp}, can be empirically determined, as shown in Equation (20) below:

$${R}_{container , emp} = \frac{ln ( \frac{{T}_{bev} - {T}_{env}}{{T}_{bev} ( 0 ) - {T}_{env}} )}{- {tmc}_{p}}$$

Second, using temperature measurements 1 and 2, along with Equations (8) and (12), a semi-empirical calculation of the inner convection resistance can be calculated. Third, using temperature measurements 2 and 3, the outer surface convection thermal resistance can be isolated.

Essentially these procedures supplement the well-established conduction analytical model with measured data to determine the more complex convection heat transfer terms. Once the thermal resistances are established, Equation (8) can be used to predict beverage temperature as a function of time. Additionally, this model can be readily adapted for use with the insulator of the present disclosure.

Thermal Model of Deployed Insulator

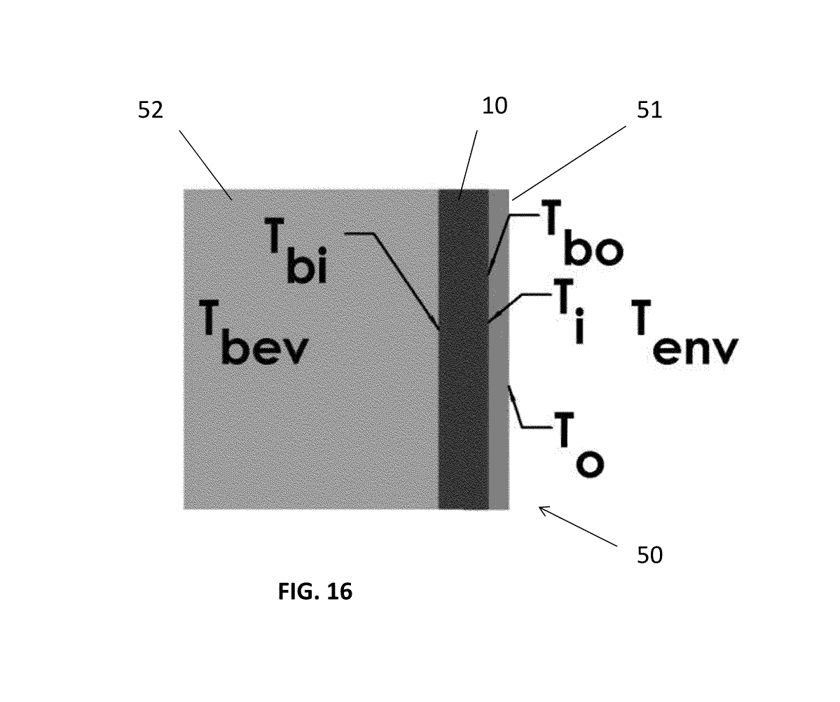

In its deployed state, the insulator 10 may create a contained cylindrical shell of air, through which thermal energy, in particular, heat, conducts before reaching the beverage. The thermal system of the insulator 10 is similar to that of a normal beverage container, except with an additional conduction resistance. This introduces two new temperatures to the overall system, the inner and outer barrier temperatures, T_{bi} and T_{bo}, respectively. FIG. 16 illustrates the locations of these temperatures. It should be noted that the insulator 10 thickness to that of the beverage container wall is NOT drawn to scale, as typically, the thickness of the insulator 10 (in its deployed state) is likely to be substantially larger than that of the container wall. Moreover, as an initial approximation, T_{bo}=Tᵢ. While there is technically a contact thermal resistance between the outer wall of the insulator 10 and the inner wall 51 of the beverage container 50, this resistance can be considered negligible in comparison to others in the thermal system. For clarity, only Tᵢ will thus be used to describe the temperature.

An exemplary thermal circuit for a beverage container outfitted with an insulator 10 is presented below:

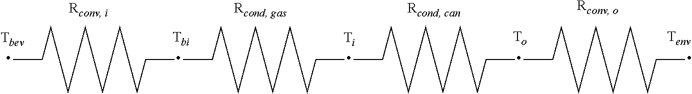

As will be demonstrated mathematically, an air gap leads to a high thermal conduction resistance, helping to insulate the beverage. The insulator thermal circuit can be modeled as shown in Equation (21) below:

$$\dot{Q} = \frac{{T}_{env} - {T}_{bev} ( t )}{{R}_{conv , i} + {R}_{cond , gas} + {R}_{cond , can} + {R}_{conv , o}}$$

Where, R_{cond,gas} is the thermal resistance through the gas filled insulator 10. It should be noted that heat also conducts through walls of the insulator 10. However, this plastic membrane is very thin and the conductive resistance may be considered negligible. Additionally, the inner convective heat transfer from the beverage to the inner wall of the insulator 10 will be slightly different than the convective transfer onto the container wall. As a first approximation, however, they can be considered similar. However, the convective resistance onto the insulator 10 will be determined empirically with initial prototypes.

Following the same mathematical procedure as with the normal container, the temperature of the beverage in the insulated container can be determined as shown in Equation (22) below:

$${T}_{bev} ( t ) = ( {T}_{env} + {T}_{bev} ( 0 ) - {T}_{env} ) {e}^{- t / τ}$$

$$τ = \frac{1}{{mc}_{p} ( {R}_{conv , i} + {R}_{cond , gas} + {R}_{cond , can} + {R}_{conv , o} )}$$

Using the empirically determined, R_{container,emp}, from Equation (20) and the solution for thermal conduction in Equation (12), the beverage temperature time constant can be solved for as a function of gas barrier thickness, as shown in Equations (23) and (24) below:

$$τ = \frac{1}{{mc}_{p} ( {R}_{cond , gas} + {R}_{container , emp} )}$$

$$τ = \frac{1}{{mc}_{p} ( \frac{ln ( \frac{{r}_{ABCI , o}}{{r}_{ABCI , i}} )}{2 π {Lk}_{gas}} + {R}_{container , emp} )}$$

Where r_{insulator,o} and r_{insulator,i} are the outer and inner radii of the insulator 10, respectively, and k_{gas} is the thermal conductivity of the gas within the I insulator 10. The outer radius of the insulator 10 is constrained as the inner radius of the beverage container, r_{container,i}. Additionally, the radii of the insulator 10 can be related by the barrier's thickness, δᵢₙₛᵤₗₐₜₒᵣ. Therefore, Equation (24) can be re-written as shown in Equation (25) below:

$$τ = \frac{1}{{mc}_{p} ( \frac{ln ( \frac{{r}_{container , i}}{{r}_{container , i} - {δ}_{ABCI}} )}{2 π {Lk}_{gas}} + {R}_{container , emp} )}$$

Equation (25) may allow for the direct optimization of beverage cooling as a function of gas barrier thickness. Moreover, this equation can be applied to the insulator 10 in both its compressed and deployed states. In the two scenarios, the insulator 10 has a different thickness, dictating its ability to conduct (or insulate). The thermal behavior in the different states is captured mathematically via the radii terms in Equation (24).

Pressure and Geometry of Insulator

With air barrier operating thickness determined by heat transfer considerations, the insulator 10 geometry can be designed. The two state functionality of the insulator 10 is enabled by the compressibility of the gas within the barrier. In the compressed state, the high pressure of the beverage collapses the gas barrier, minimizing the thermal resistance for refrigeration. In the expanded state, the insulator 10 is at operating thickness, to maximize thermal resistance and insulate the beverage.

First, the expanded state of the insulator is considered. The beverage container is exposed to atmospheric pressure. The requirements of this scenario are that the insulator maintains its thickness in order to insulate the beverage. The main pressure acting to collapse the insulator 10 is the hydraulic pressure of the beverage. At the top of the liquid column, the pressure will be equal to atmospheric pressure, Pₐₜₘ. However, the pressure rises linearly with depth into the beverage container, as shown in Equation (26) below:

P_{bev}=ρgd

Where d is the depth measured from the beverage/air interface. Therefore, the maximum beverage pressure will occur at the bottom of the container and will be equal to, as shown in Equation (27) below:

P_{bev,max}=ρgdₘₐₓ

Where dₘₐₓ is the maximum depth of the beverage in the container. This value is near (and can be reasonably approximated as) the height of beverage container. As a result of the beverage pressure, the pressure in the expanded gas barrier is equal to the linear averaged integral of beverage pressure (assuming uniform azimuthal distribution), as shown in Equation (28) below:

$${P}_{gas , expanded} = \frac{{\int }_{0}^{{d}_{max}} ρ g d d d}{{d}_{max}}$$

During manufacture, in some embodiments, the pressure inside the gas barrier may be set at minimum to the value of P_{gas,expanded}. However, the minimum set pressure can also be considered P_{bev,max}. With the internal gas pressure higher than this threshold, the insulator 10 may not collapse during beverage consumption.

Next, the volume of the insulator in its expanded state is considered. This can be calculated simply, as shown in Equation (29) below:

V_{gas,expanded}=π[2R_{can,inner}δ_{insulator,expanded}−δ_{insulator,expanded}²]L_{insulator,expanded}

Where, R_{can,inner}δ_{insulator,expanded} and Lᵢₙₛᵤₗₐₜₒᵣ are the inner radius of the can and the expanded thickness and height the insulator 10, respectively.

Under reasonable conditions, the gas within the insulator 10 can be modeled as an ideal gas (in some embodiments, this gas will be air). As such, it will hold true that, as shown in Equation (30) below:

$${PV}^{γ} = constant$$

$$γ = \frac{{c}_{p}}{{c}_{v}}$$

In this relationship, γ is the ratio of specific heat at constant pressure, cₚ, and specific heat at constant volume, cᵥ. However, for diatomic gases—such as nitrogen and oxygen, the main constituents of air—as an approximation, γ=7/5.

Using Equation (30), the expanded and compressed states of the insulator 10 can be compared, as shown in Equation (31) below:

P_{gas,expanded}V_{gas,expanded}^{γ}=P_{gas,compresses}V_{gas,compressed}^{γ}

The compressed gas pressure, P_{gas,compressed}, will be equal to the pressure of the pressurized beverage, P_{bev,pressurized}. The compressed gas volume, V_{gas,compressed} can be solved for using Equation (31). Subsequently, the compressed thickness of the insulator 10, δ_{insulator,compressed} can determined. This enables the determination of the thermal resistance of the compressed insulator 10, which is desirable to minimize for rapid refrigeration.

In some embodiments, if a small enough compressed thickness cannot be realized, it is possible to include a gas reservoir in the insulator 10. This small reservoir would offer a volume for the mass of gas to occupy during the compressed state. Theoretically, such a feature could allow for δ_{insulator, compressed} to be equal to zero.

Another design consideration is the volume of beverage displaced by the expanded volume of the insulator 10. The nominal volume of the standard sized beverage container, V_{container,nominal}, will be reduced by the gas barrier volume. This can simply be accepted and regular container dimension maintained, with less usable internal volume for beverage. Alternatively, the container can be enlarged to maintain the nominal volume even with the inclusion of the gas barrier. If this latter option is explored, it is likely that the diameter of the container will remain constrained (due to cup holder size, ergonomics, and an regularly accepted aspect ratio). However, the height of the container can be increased.

Given a gas barrier volume, the container height may be increased, as shown in Equation (32) below:

$${L}_{container , new} = \frac{{V}_{gas , expanded}}{π {r}_{insulator , i}^{2}}$$

The height of the insulator 10 may also be increased to the new container height, L_{container,new}. In optimizing the design, the ratio of the new container height to the original container height, L_{container,original}, as shown in Equation (33), may be considered

$$Container Height Ratio = \frac{{L}_{container , new}}{{L}_{container , original}}$$

Gas Cooling Effect

Beyond acting as an insulator, the gas volume within the insulator 10 may realize a decrease in temperature during expansion. Pressure, volume and temperature of an ideal gas are related by the ideal gas law, as shown in Equation (34) below:

$$\frac{PV}{T} = constant$$

The compressed and expanded pressures and volumes can be determined. Therefore, the decrease in temperature during gas expansion is solved, as shown in Equations (35) and (36) below:

$$Δ {T}_{gas , expansion} = \frac{{P}_{gas , expanded} {V}_{gas , expanded}}{{P}_{gas , compressed} {V}_{gas , compressed}}$$

$${T}_{gas , expanded} = \frac{{P}_{gas , expanded} {V}_{gas , expanded} {T}_{gas , compressed}}{{P}_{gas , compressed} {V}_{gas , compressed}}$$

This effect will act as an instantaneous refrigeration burst, helping to cool the beverage further during consumption.

Thermal Mass and Inertia of Gas

It should also be noted that the gas inside the insulator 10 can also absorb thermal energy from the surrounding environment. This is beneficial to beverage insulation as the initially cold gas mass must also change in temperature as the liquid does. Because the overall thermal transfer to the container from the environment may be limited by the external surface area, the added air mass will delay the warming or cooling process of the beverage.

### EXAMPLES

The devices, systems and methods of the present disclosure are described in the following Examples, which are set forth to aid in the understanding of the disclosure, and should not be construed to limit in any way the scope of the disclosure as defined in the claims which follow thereafter. The following examples are put forth so as to provide those of ordinary skill in the art with a complete disclosure and description of how to make and use the embodiments of the present disclosure, and are not intended to limit the scope of what the inventors regard as their invention nor are they intended to represent that the experiments below are all or the only experiments performed. Efforts have been made to ensure accuracy with respect to numbers used (e.g. amounts, temperature, etc.) but some experimental errors and deviations should be accounted for.

### Example 1

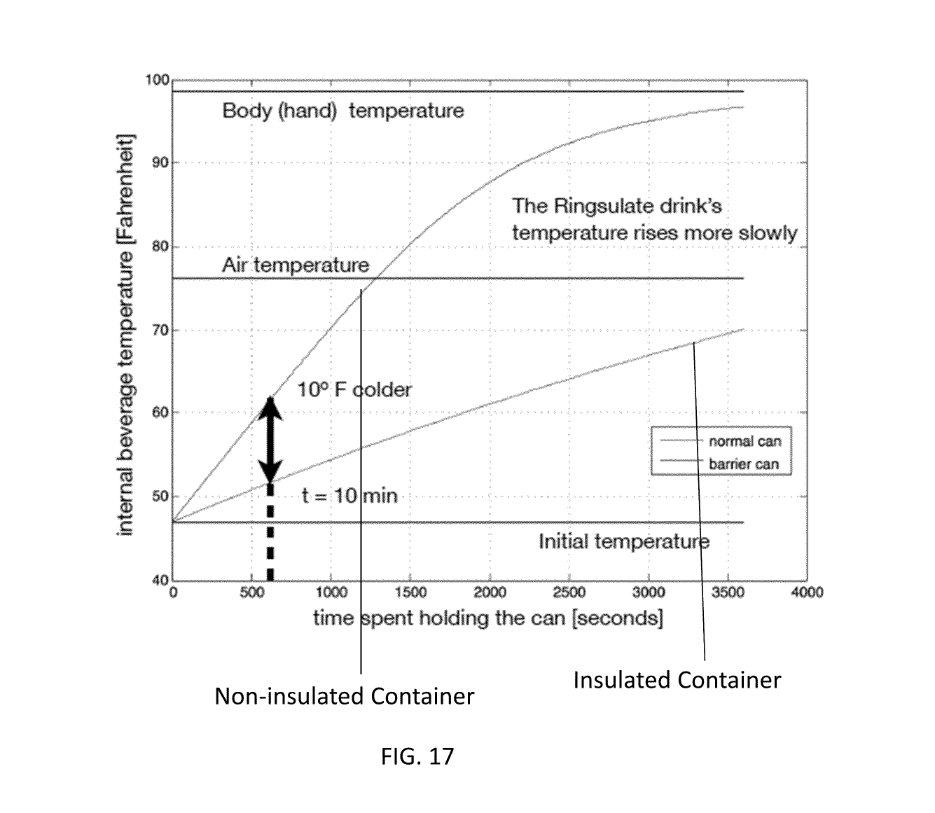

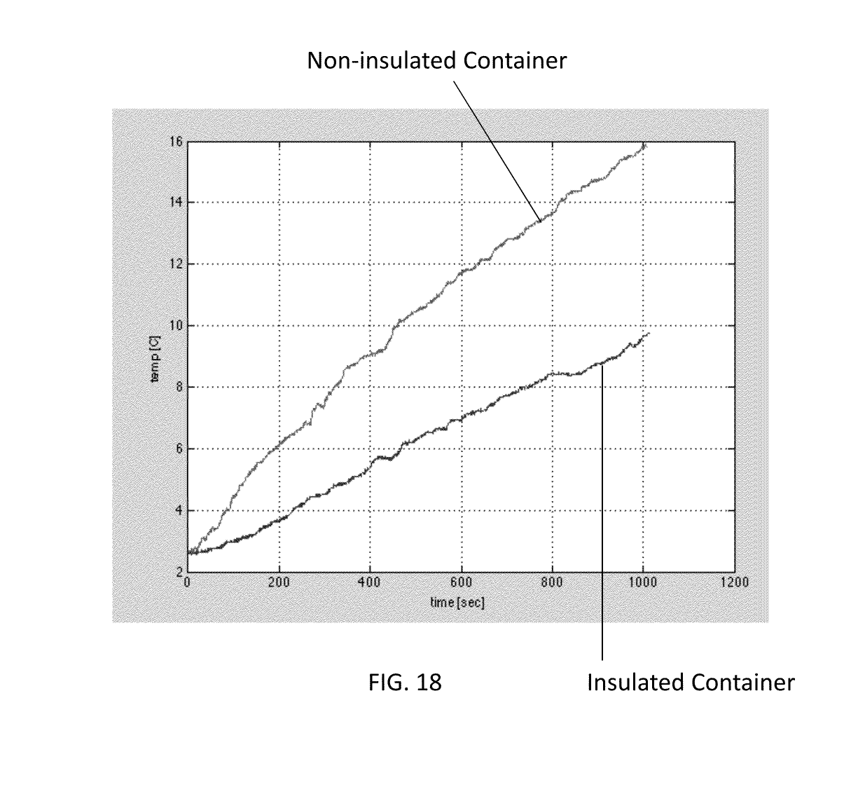

Behavior of an insulator having a thickness of about 0.06 inches (1.5 mm) when inflated was modeled. As can be seen in FIG. 17, after about 10 minutes, a beverage in the insulated container is expected to be about 10° F. cooler than a similar beverage in a non-insulated container.

### Example 2

An insulator was prepared from two sheets of plastic, heat sealed together to create an inner volume and then formed into a cylinder. One of the plastic sheets was about 1.5 mm polyethylene and the other was bubble wrap type material. In the construction, the inflated bubbles were facing inwards (towards the inner volume). The bubbles had approximate dimensions of 5/16 inches in diameter, 3/16 inches in height, and a site density of 3 bubbles/square inch. The bubble wrap material was also made of polyethylene. The height of the insulator was about 4 inches. The insulator fit snugly within the can, but was not adhered to the side walls. As can be seen in FIG. 18, after about 10 minutes, a beverage in the insulated container was about 5° C. cooler than a similar beverage in a non-insulated container.

All patents, patent applications, and published references cited herein are hereby incorporated by reference in their entirety. It will be appreciated that various of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

What is claimed is:

1. An insulated container comprising:
a container for holding therein one or more substances in need of insulation;
an insulator disposed inside the container, the insulator being moveable between a compressed state when the container is pressurized and an expanded state when the container is de-pressurized.

2. The insulated container of claim 1, wherein the insulator defines an inner volume for holding an insulating material.

3. The insulated container of claim 2, wherein the inner volume defined by the insulator is divided into a plurality of smaller volumes for holding the insulating material.

4. The insulated container of claim 2 further comprising a stiffener disposed within the inner volume for supporting the insulator in the expanded state.

5. The insulated container of claim 1, wherein the insulator is a double-wall insulator having a first wall and a second wall defining a sealed inner volume filled with an insulating material.

6. The insulated container of claim 1, wherein the insulator is moveable to the compressed state to permit thermal transfer between the one or more substances and the environment outside of the container.

7. The insulated container of claim 1, wherein the insulator is moveable to the expanded state to reduce thermal transfer between the one or more substances and the environment outside of the container.

8. The insulated container of claim 1, wherein the insulator is formed by a wall of the container and a flexible secondary wall positioned inwardly of the wall of the container.

9. The insulated container of claim 8 wherein the secondary wall is configured to be pressed against the wall of the container when the container is pressurized and to be spaced apart from the wall of the container when the container is de-pressurized.

10. The insulated container of claim 1, wherein the insulator comprises compressible foam.

11. The insulated container of claim 1, wherein the insulator abuts an inner surface of the container.

12. An insulated container comprising:
an insulator configured to fit inside a container for holding therein one or more substances in need of insulation;
an insulating volume defined by a first side and a second side of the insulator; and
an insulating material disposed inside the insulating volume,
wherein the insulator is moveable from a compressed state to an expanded state in response to change in pressure of the one or more substances.

13. The insulated container of claim 12, wherein the insulating volume is divided into a plurality of smaller volumes filed with the insulating material.

14. The insulated container of claim 12 further comprising a stiffener disposed within the insulating volume for supporting the insulator in the expanded state.

15. The insulated container of claim 12, wherein the insulator is moveable to the compressed state to permit thermal transfer between the one or more substances and the environment outside of the container.

16. The insulated container of claim 12, wherein the insulator is moveable to the expanded state to reduce thermal transfer between the one or more substances and the environment outside of the container.

17. A method for insulating a substance inside a container, the method comprising:
disposing an insulator inside an container holding one or more substances therein;
compressing the insulator by pressurizing the container to permit thermal transfer into the one or more substances from environment outside of the container; and
allowing the insulator to expand by depressurizing the container to reduce the thermal transfer into the one or more substances from the environment outside of the container.

18. The method of claim 17, wherein, in the step of disposing, the insulator is a double-wall insulator having a first wall and a second wall defining a sealed inner volume filled with an insulating material.

19. The method of claim 17, wherein, in the step of disposing, the insulator is formed by a wall of the container and a flexible secondary wall positioned inwardly of the wall of the container.

20. The method of claim 17, wherein, in the step of disposing, wherein the insulator comprises compressible foam.
